(19) United States
(12) Patent Application Publication
(10) Pub. No.: US 2026/0062071 A1
(43) Pub. Date: Mar. 5, 2026

(54) SELF-PROPELLED AGRICULTURAL MACHINE WHOSE BALANCE CAN BE CONTROLLED AND ADJUSTED

(71) Applicant: KUHN SAS, Saverne (FR)

(72) Inventors: Sébastien NUSSBAUMER, Chevry (FR); Thomas SCHMITT, Diemeringen (FR)

(73) Assignee: KUHN SAS, Saverne (FR)

(21) Appl. No.: 19/106,077

(22) PCT Filed: Sep. 11, 2023
(86) PCT No.: PCT/EP2023/074877

§ 371 Date: Feb. 24, 2025

(30) Foreign Application Priority Data
Sep. 12, 2022 (FR) FR2209117

(51) Int. Cl. B62D 37/04; A01B 51/02; B62D 49/06

(52) U.S. Cl. CPC B62D 37/04; A01B 51/02; B62D 49/06

(57) ABSTRACT

An agricultural machine, of which the assembly connection between the support frame and the running-gear allows a movement between the support frame and the running-gear along the longitudinal axis. The machine includes a device for determining and optionally adjusting, if necessary, automatically by an evaluation and control device or on command of an operator. The relative positioning between the support frame and the running-gear is set such the center of gravity of the support frame with its tool and a central point of the running-gear are mutually close, advantageously located in a same plane perpendicular to the longitudinal axis and preferably coincident.

The present invention relates to the field of agricultural machinery, more specifically the balancing and safety of agricultural machines likely to be fitted with tools of different types and weights, possibly variable, and relates to an agricultural machine whose balance can be controlled and adjusted.

The invention relates in particular to a self-propelled agricultural machine, operated autonomously or controlled by an operator, having a usual direction of advance, which determines the front and rear, and a longitudinal axis for the machine. The type of agricultural machine concerned comprises, on the one hand, a carrier frame configured to carry at least one tool at the front and/or at the rear and, on the other hand, a rolling assembly. The latter comprises, as rolling means, either at least one tracked undercarriage, and possibly at least one additional undercarriage with a wheeled axle, or at least two undercarriages with wheeled axles, the carrier frame being mounted on and assembled with the rolling assembly and carrying at least one tool.

Therefore, depending on the tools carried or hitched to the front or rear, their variation in weight and/or position, the center of gravity of the upper part of the machine (carrier frame+tools), and therefore of the machine as a whole, may be offset to varying degrees relative to the ground supports of the machine, resulting in particular in instability and reduced performance during the displacement of the machine, possible deformation of parts thereof, uneven wear of the undercarriages and a deviation from instructions for machines with autonomous operation.

These drawbacks are particularly penalizing for tracked agricultural machines and result, for example, in:
too much ground pressure by areas, as the load is distributed unevenly
a ground contact surface area less than the lower surface area of the tracks, since the machine tilts forwards or backwards, and the tracks are not therefore fully in contact with the ground: the traction and stability of the vehicle are therefore not optimal
the need for additional ballasting to compensate for the poor distribution of the weight, which leads to an unnecessary additional ground load and therefore a greater compressing of the soil, which is of course not desired.

In addition, some tools have hoppers or tanks (seed drills, spreaders for various fertilizers, plant protection product sprayers, etc.). As work in a plot of land progresses, these tanks will empty and then be filled again by the farmer until the work is completed. These changes imply a significant change in weight, and therefore a change in the position of the center of gravity.

Furthermore, a tracked vehicle whose center of gravity is not coincident with its instant center of rotation is more difficult to guide autonomously (via GPS), since the guidance system needs to be recalibrated each time the position of the center of gravity changes. This recalibration involves a complex algorithm for managing the direction commands for each of the tracks.

The present invention aims to overcome these drawbacks, and not only for tracked agricultural machines.

To this end, its subject is an autonomous agricultural machine of the type mentioned in the introduction, characterized in that the connecting link between the carrier frame and the rolling assembly is configured to allow displacement between this frame and this assembly along the longitudinal axis, and in that it comprises means for determining and possibly adjusting, if necessary, automatically by an evaluation and control means or upon a command from an operator informed by said means, the relative positioning between the carrier frame and the rolling assembly, in such a way that the center of gravity of the carrier frame with its tool(s) and a central point of the rolling assembly are close to each other, advantageously located in a same plane perpendicular to the longitudinal axis, and preferably coincident.

The invention will be better understood through the following description, which refers to preferred embodiments given as non-limiting examples and explained with reference to the attached schematic drawings, in which:

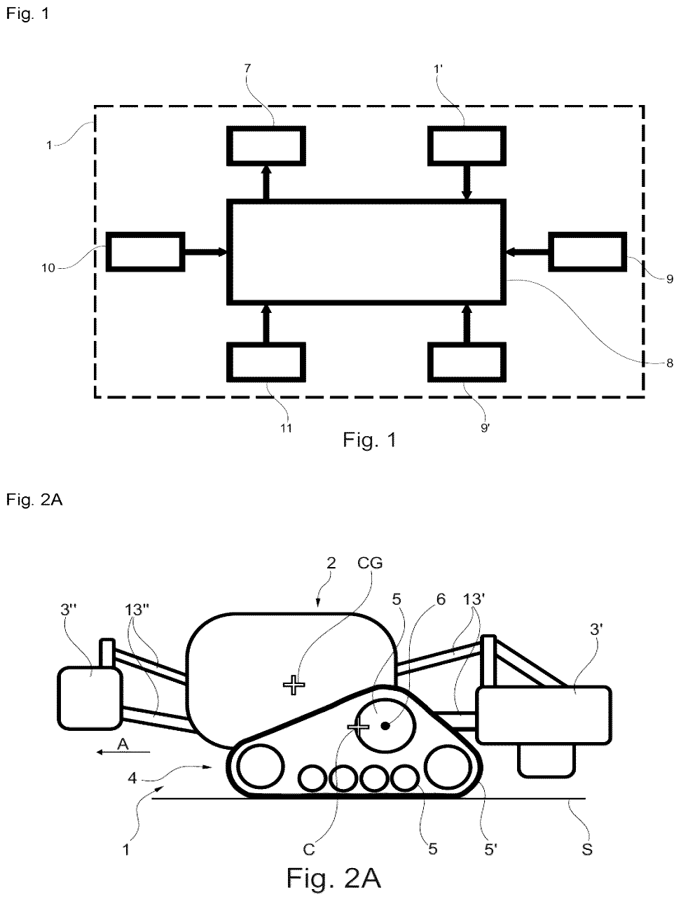

FIG. 1 is a functional schematic representation of a self-propelled agricultural machine according to the invention;

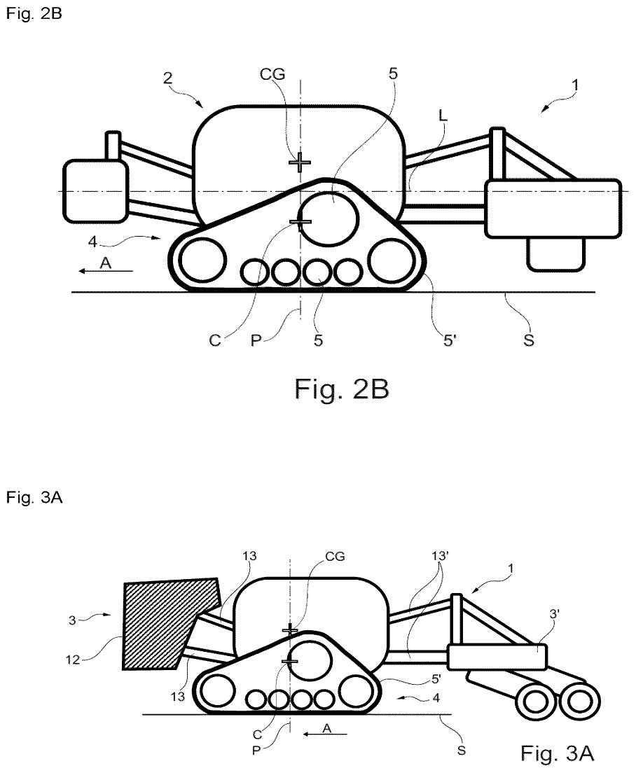

FIG. 2A and

FIG. 2B are schematic side elevation views of an agricultural machine according to a first variant of a first embodiment of the invention (tracked undercarriage), respectively in an unbalanced configuration (FIG. 2A) and in a balanced configuration (FIG. 2B);

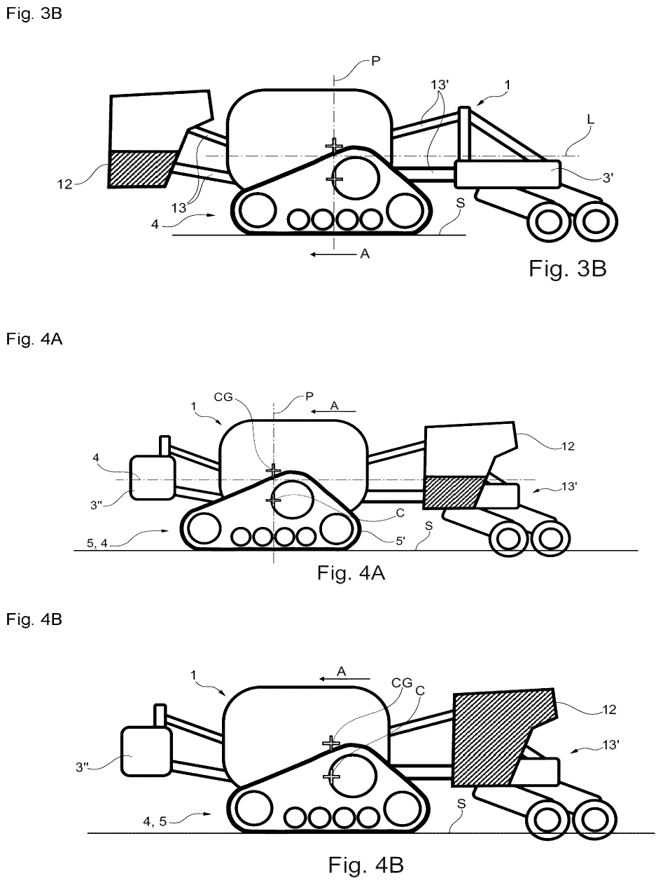

FIG. 3A and

FIG. 3B are schematic side elevation views of an agricultural machine according to a second variant of the first embodiment of the invention (tracked undercarriage), in two balanced configurations despite different levels in the front-mounted hopper, thanks to the controlled offset between the carrier frame and the rolling assembly;

FIG. 4A and

FIG. 4B are schematic side elevation views of an agricultural machine according to a third variant of the first embodiment of the invention (tracked undercarriage), in two balanced configurations despite different levels in the rear-mounted hopper, thanks to the controlled offset between the carrier frame and the rolling assembly;

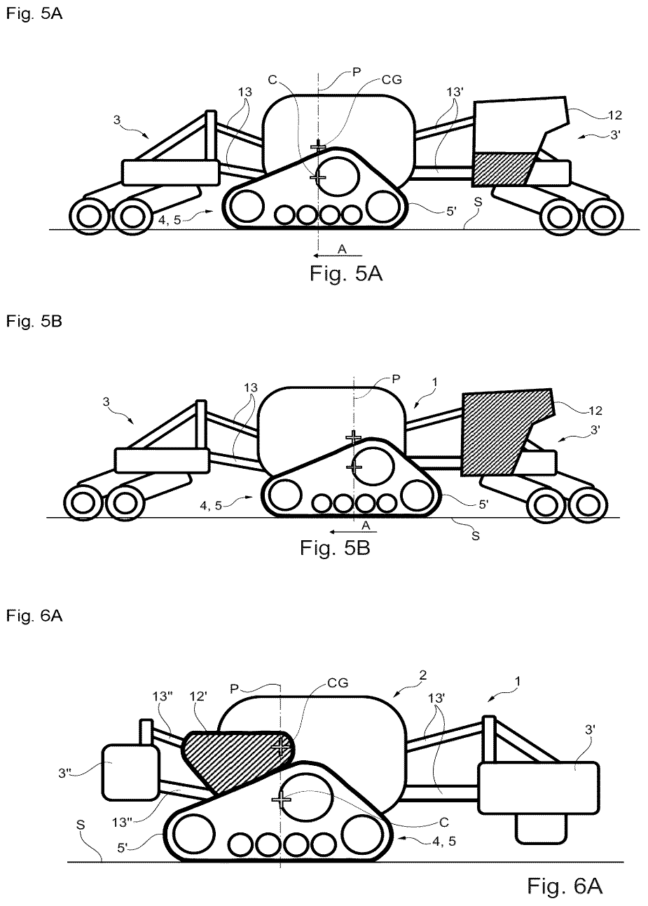

FIG. 5A and

FIG. 5B are schematic side elevation views of an agricultural machine according to a fourth variant of the first embodiment of the invention (tracked undercarriage), in two balanced configurations despite different levels in the rear-mounted hopper, thanks to the controlled offset between the carrier frame and the rolling assembly;

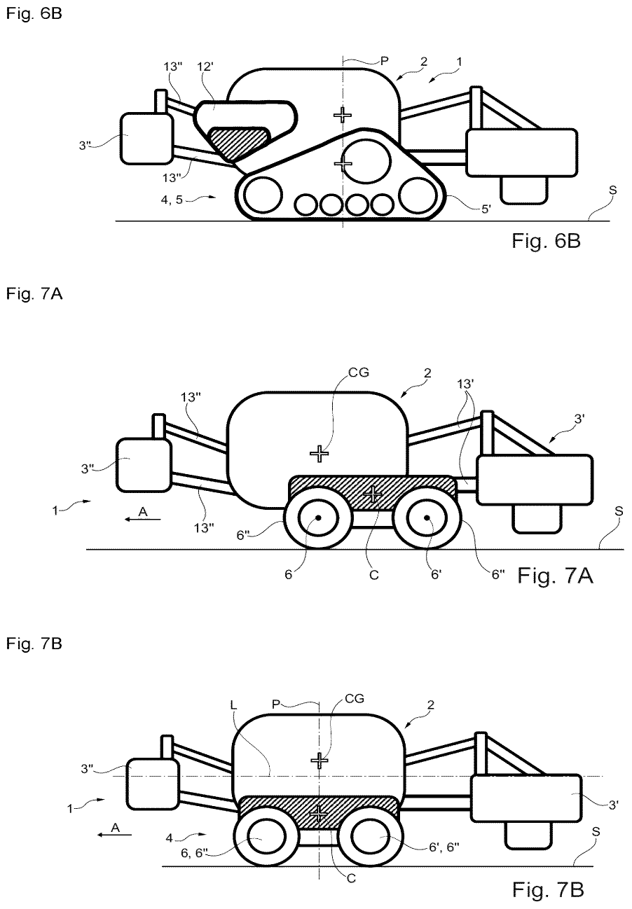

FIG. 6A and

FIG. 6B are schematic side elevation views of an agricultural machine according to a fifth variant of the first embodiment of the invention (tracked undercarriage), in two balanced configurations despite different levels in the fuel tank, thanks to the controlled offset between the carrier frame and the rolling assembly;

FIG. 7A and

FIG. 7B are schematic side elevation views of an agricultural machine according to a first variant of a second embodiment of the invention (undercarriage with wheeled axles), respectively in an unbalanced configuration (FIG. 7A) and in a balanced configuration (FIG. 7B);

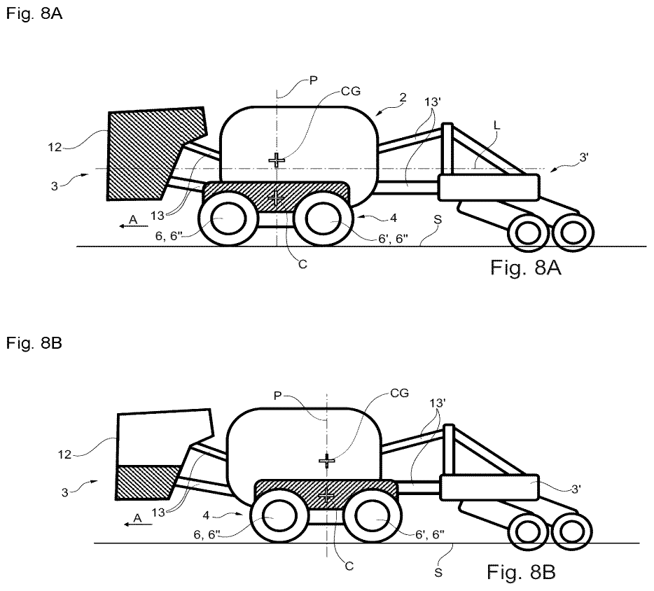

FIG. 8A and

FIG. 8B are schematic side elevation views of an agricultural machine according to a second variant of the second embodiment of the invention (undercarriage with wheeled axles), in two balanced configurations despite different levels in the front-mounted hopper, thanks to the controlled offset between the carrier frame and the rolling assembly;

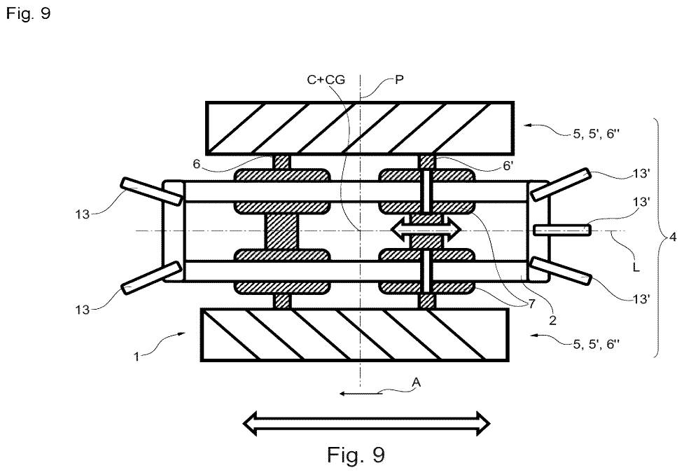

FIG. 9 is a simplified schematic top view of a machine according to FIGS. 2 to 8, the tools and other equipment carried by the carrier frame being removed to view the connecting link between the rolling assembly and the carrier frame, and,

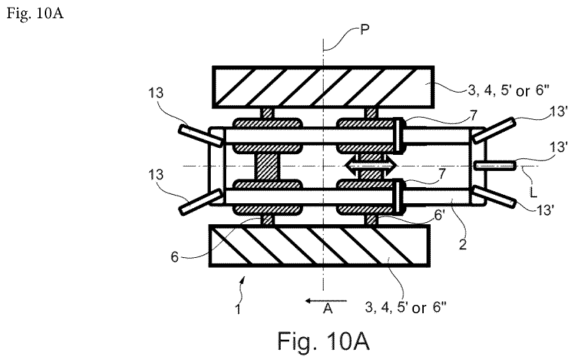

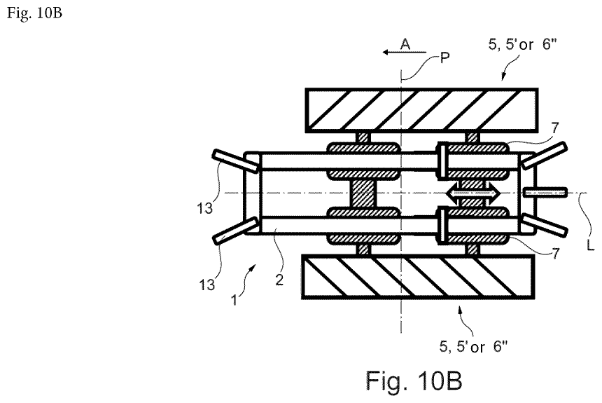

FIG. 10A and

FIG. 10B are views similar to FIG. 9, showing the rolling assembly in two extreme offset positions along the longitudinal axis with respect to the carrier frame, respectively in the maximum front position (10A) and in the maximum rear position (10B).

FIGS. 1 to 8 illustrate a self-propelled agricultural machine (1), operated autonomously or controlled by an operator, having a usual direction of advance (A), which determines the front and rear of the machine, and a longitudinal axis (L) for that machine (1).

This agricultural machine (1) comprises, on the one hand, a carrier frame (2) configured to carry at least one tool (3, 3′) at the front and/or at the rear and, on the other hand, a rolling assembly (4) comprising, as rolling means, either at least one undercarriage (5) with tracks (5′), and possibly at least one additional undercarriage with an axle (6, 6′) with wheels (6″), or at least two undercarriages with axles (6, 6′) with wheels (6″), the carrier frame (2) being mounted on and assembled with the rolling assembly (4) and carrying at least one tool (3, 3′).

As also shown by way of example in FIGS. 2 to 8, the tool, at least one of the tools or both front and rear tools (3, 3′) can be mounted fixed or movably on the carrier frame (2) and have a constant or variable weight. In particular, the tool or one of the tools (3, 3′) may comprise a hopper (12) or similar tank, which empties and/or fills as the machine (1) is working, either progressively or occasionally. In addition, the carrier frame (2) may carry a ballast weight (3″) at the front or at the rear, which may be movable, or attached via a ballast weight holder (13″) or similar. The different interchangeable tools and similar equipment of the machine (1) are generally rigidly fastened to and carried by the carrier frame (2), by means of hitching devices with front (13) and rear (13′) linkage. However, it is of course understood that other equipment necessary and useful for the operation of the machine (1), as well as certain tools, are likely to be mounted above the carrier frame or attached and locked in position on the top of the machine, or even attached underneath the latter.

According to the invention, the agricultural machine (1) is characterized in that the connecting link between the carrier frame (2) and the rolling assembly (4) is configured to allow displacement between this frame and this assembly along the longitudinal axis (L), and in that it comprises means for determining and possibly adjusting, if necessary, automatically by an evaluation and control means (8) or upon a command from an operator informed by said means (8), the relative positioning between the carrier frame (2) and the rolling assembly (4), in such a way that the center of gravity (CG) of the carrier frame (2) with its tool(s) (3, 3′) and a central point (C) of the rolling assembly (4) are close to each other, advantageously located in a same plane (P) perpendicular to the longitudinal axis (L), and preferably coincident.

Ideally, it is assumed that the machine (1) is balanced transversely with respect to a plane containing the longitudinal axis (L) and perpendicular to the plane (P). However, the balancing according to the invention can also be implemented when such transverse balancing is not verified. In this case, in FIGS. 2 to 8, the crosses will not represent the aforementioned center of gravity (CG) and central point (C), but horizontal lines enclosing them and perpendicular to the longitudinal axis (L), and the same situation will be sought, with them being close together, advantageously coplanar, and preferably coincident.

The invention therefore makes it possible to overcome the aforementioned drawbacks and proposes a simple and integrated solution making it possible to i) achieve an optimized relative positioning between the carrier frame (2) and the rolling assembly (4), based on a given configuration of the different weights corresponding to the tools or similar accessories carried by the carrier frame (2), and ii) maintain or return to such an optimized positioning when the distribution of the weights either changes due to a change in the carried movable tools or accessories, or changes during a working phase or between two consecutive working phases of the machine (1).

By implementing and maintaining a centralized positioning of the carrier frame (2) with respect to the rolling assembly (4), optimum stability of the machine (1) and maximum contact with the ground (S) is achieved, as well as a load substantially distributed across the support surfaces, resulting in optimized grip and traction. In addition, a consequent limitation of the ballasting requirement enables reducing the impact on the ground (S). Furthermore, GPS guidance of the machine (1) is facilitated, since the center of gravity and the instant center of rotation are always coincident. Furthermore, in the event of a change in the weight of a tool (for example emptying a hopper), the progress of this variation can be monitored indirectly by monitoring the adjustment of the relative positioning. Lastly, it should be noted that the solution of the invention is compatible with all types of tools, accessories, equipment and weights, and adapted to all the configurations of linkage for tools or attaching ballast weights.

According to a first embodiment variant, the central point (C) of the rolling assembly (4) corresponds to the geometric center or barycenter of the contact areas between the undercarriages (5, 5′; 6, 6′, 6″) and the ground (S).

According to a second embodiment variant, and when the rolling assembly (4) comprises only an undercarriage (5) with tracks (5′), the central point (C) of the rolling assembly (4) corresponds to the geometric center of the undercarriage (5) or to the midpoint of a drive axle of this undercarriage (5).

According to a third embodiment variant, and when the rolling assembly (4) comprises two undercarriages (5, 5′; 6, 6′, 6″), the central point (C) corresponds to the median point between the geometric centers of the axles of the two undercarriages (5, 5′; 6, 6′, 6″).

As shown diagrammatically in FIGS. 9 and 10, the connecting link between the carrier frame (2) and the rolling assembly (4) has a degree of freedom for sliding along the longitudinal axis (L) and comprises one or more cylinders (7), which can be locked in position, the actuation of at least some of which, in particular of at least one electric cylinder provided with a position sensor, results in a relative sliding displacement between the frame and the assembly.

As illustrated in particular in FIGS. 3 to 5 and 8, the tool (3, 3′) or at least one of the tools (3, 3′) carried by the carrier frame (2) may have a variable weight and/or may be moved relative to the carrier frame (2), in particular during use or when changing the machine (1) from one configuration or from one state to another, the agricultural machine (1) comprising measuring means (9) for the ballast weight and relative position detection means (9′) with regard to the carrier frame (2) of the tool or of each of the tools (3, 3′) mounted at the front or at the rear. These means (9, 9′), in the form of sensors, which make it possible to monitor the evolution of the position and the weights corresponding in particular to the various tools and ballasting, allow a dynamic adjustment of the relative positioning of the two target components (2 and 4).

As an alternative non-dynamic variant, it is possible to envisage a system without weighing where the weights are known via a catalog of possible tools for the machine concerned or via a manual input by the user on a control terminal of the machine (“FRONT tool=X kg, REAR tool=Y kg”).

According to an advantageous embodiment of the invention, illustrated schematically in FIG. 1, and allowing a dynamic controlled adjustment of the ideal relative positioning of the two components (2 and 4), the machine (1) comprises an evaluation and control means (8) which is configured to i) analyze the data provided by a measuring means (1′) for the balance of the machine (1), for example a balance device (measurement of the inclination with respect to the horizontal position), and/or by a database (10), ii) determine an optimal relative positioning between the carrier frame (2) and the rolling assembly (4), and iii) if necessary, either perform an adjustment by controlling a relative displacement between the carrier frame (2) and the rolling assembly (4), or inform an operator, if the center of gravity (CG) of the carrier frame (2) with its tool(s) (3, 3′) and a central point (C) of the rolling assembly (4) do not at least approximately coincide. The computer type means (8) will operate under the control of a specific adapted management and control software.

Preferably, the machine (1) comprises an evaluation and control means (8) which is configured and programmed to: i) analyze the data supplied, on the one hand, by measuring means (9) for the ballast weight of the tool (3, 3′) or tools (3 and 3′) mounted at the front or at the rear, and on the other hand, by relative position detection means (9′) for the tool (3, 3′) or tools (3 and 3′) mounted at the front or at the rear and movable with respect to the carrier frame (2), for example by raising/lowering, and/or, lastly, by a database (10), ii) determine an optimal relative positioning between the carrier frame (2) and the rolling assembly (4), and iii) if necessary, either perform an adjustment by controlling a relative displacement between the carrier frame (2) and the rolling assembly (4), or inform an operator, if the center of gravity (CG) of the carrier frame (2) with its tool(s) (3, 3′) and a central point (C) of the rolling assembly (4) do not at least approximately coincide.

According to another favorable feature of the invention, the machine (1) also comprises a database (10) providing predefined states of optimal relative positioning between the carrier frame (2) and the rolling assembly (4), based on the type of tool(s) (3, 3′) or ballast weight(s) (3″) mounted at the front and/or at the rear, and means (11) for detecting the type of tool(s) (3, 3′) or ballast weight(s) (3″) mounted.

In relation to the above-mentioned arrangements, the evaluation and control means (8) can favorably be programmed to analyze the data supplied by the means (11) for detecting the type of tool(s) (3, 3′) or ballast weight(s) (3″) mounted and to consult the database (10), at least at the beginning of a working or moving phase of the agricultural machine (1), and to possibly (if necessary) adjust the relative positioning between the carrier frame (2) and the rolling assembly (4) and/or inform an operator. It is therefore possible to define, at the beginning of a given phase, a balanced initial configuration of the machine (1).

Also in relation to the above-mentioned arrangements, the evaluation and control means (8) may be favorably programmed to i) analyze repeatedly, if necessary almost continuously, the data provided either by a measuring means (1′) for the balance of the machine (1), or by measuring means (9) for the ballast weight and relative position detection means (9′) for the tool (3, 3′) or tools (3 and 3′) mounted at the front or at the rear, and ii) automatically determine and repeatedly adjust, if necessary in real time and continuously, the relative positioning between the carrier frame (2) and the rolling assembly (4), throughout a working phase of the agricultural machine (1). Therefore, in the case of a tool of variable weight (for example incorporating a hopper that empties as the machine is working), a balanced configuration can be guaranteed at all times (see FIGS. 3 to 5 and 8).

In fully autonomous operation of the machine (1), for example of the agricultural robot type, the dynamic adjustment is carried out without the intervention of the user as the work progresses in the plot of land and according to the requirements of the machine. It may also be possible for the machine to send a warning signal to the user (via the control interface of the vehicle) to indicate an imbalance or a poor distribution of the weights. An optimized adjustment for the position of the tracks (5′) can then be suggested to the operator to resolve the problem.

In relation to another advantageous feature of the invention, and as shown by way of example in FIG. 6, the evaluation and control means (8) can also be programmed to also take into account the level of filling of the fuel tank (12′) of the agricultural machine (1), and its evolution during the working phase, in order to determine and, if necessary, adjust an optimal relative positioning between the carrier frame (2) and the rolling assembly (4).

Another subject of the invention is, in order to overcome the drawbacks of the state of the art, a method for managing the configuration of an agricultural machine (1) of the type mentioned in the introduction to the present invention, and in particular of an agricultural machine (1) with the technical provisions and features mentioned above.

According to the invention, this method consists of providing a connecting link between the carrier frame (2) and the rolling assembly (4), which is configured to allow displacement between this frame and this assembly along the longitudinal axis (L), and consists of determining and possibly adjusting, if necessary, automatically by an evaluation and control means (8) or upon a command from an operator informed by said means (8), the relative positioning between the carrier frame (2) and the rolling assembly (4), in such a way that the center of gravity (CG) of the carrier frame (2) with its tool(s) (3, 3′) and a central point (C) of the rolling assembly (4) are close to each other, advantageously located in a same plane (P) perpendicular to the longitudinal axis (L), and preferably coincident.

The position change of the undercarriage (5) with tracks (5′) ideally takes place only in the two scenarios below:
Initial adjustment before the start of work: static machine (1) and tools (3, 3′) hitched (with hoppers filled to the required level if applicable)
Dynamic adjustment: in a straight line only to reduce the risk of stability problems for the equipped and loaded machine (1), which could occur if the dynamic offset should be carried out on a bend, while performing a U-turn or a maneuver.

It can also be possible for the machine (1) to adopt one of several predefined configurations (each corresponding to a predetermined relative positioning between the frame and the rolling assembly), namely:
a “transport” configuration: for minimum space requirement or optimum stability (if tools are held/attached)
a “working” configuration with application of the rule: if combination of tools X+Y attached to the vehicle, then the rolling assembly comes to position Z. A “catalog” of known tools can be integrated into the management software controlling the agricultural machine.

Obviously, the invention is not limited to the embodiments described and shown in the attached drawings. Modifications remain possible, in particular as regards the composition of the various elements or the substitution by technical equivalents without however departing from the scope of protection of the invention.

1. A self-propelled agricultural machine, operated autonomously or controlled by an operator, having a usual direction of advance, which determines the front and rear, and a longitudinal axis for the machine, said agricultural machine comprising:
a carrier frame configured to carry at least one tool at the front and/or at the rear; and
a rolling assembly comprising, as rolling means, either at least one undercarriage with tracks, and possibly at least one additional undercarriage with an axle with wheels, or at least two undercarriages with axles with wheels, the carrier frame being mounted on and assembled with the rolling assembly and carrying the at least one tool,
wherein the connecting link between the carrier frame and the rolling assembly is configured to allow displacement between this frame and this assembly along the longitudinal axis, and
wherein the agricultural machine comprises means for determining and possibly adjusting, if necessary, automatically by an evaluation and control means or upon a command from an operator informed by this means, the relative positioning between the carrier frame and the rolling assembly, in such a way that the center of gravity of the carrier frame with its tool(s) and a central point of the rolling assembly are close to each other, advantageously located in a same plane perpendicular to the longitudinal axis, and preferably coincident.

2. The agricultural machine according to claim 1, wherein the central point of the rolling assembly corresponds to the geometric center or barycenter of the contact areas between the undercarriages and the ground.

3. The agricultural machine according to claim 1, wherein the rolling assembly comprises only an undercarriage with tracks, the central point of the rolling assembly corresponding to the geometric center of the undercarriage or to the midpoint of a drive axle of this undercarriage.

4. The agricultural machine according to claim 1, wherein the rolling assembly comprises two undercarriages, the central point corresponding to the median point between the geometric centers of the axles of the two undercarriages.

5. The agricultural machine according to claim 1, wherein the connecting link between the carrier frame and the rolling assembly has a degree of freedom for sliding along the longitudinal axis and comprises one or more cylinders, which can be locked in position, the actuation of at least some of which, in particular of at least one electric cylinder provided with a position sensor, results in a relative displacement between the carrier frame and the rolling assembly.

6. The agricultural machine according to claim 1, wherein the tool or at least one of the tools carried by the carrier frame may have a variable weight and/or may be moved relative to the carrier frame, in particular during use or when changing the machine from one configuration or from one state to another, the agricultural machine comprising measuring means for the ballast weight and relative position detection means with regard to the carrier frame of the tool or of each of the tools mounted at the front or at the rear.

7. The agricultural machine according to claim 1, further comprising an evaluation and control means which is configured to i) analyze the data provided by a measuring means for the balance of the machine, for example a balance device, and/or by a database, ii) determine an optimal relative positioning between the carrier frame and the rolling assembly, and iii) if necessary, either perform an adjustment by controlling a relative displacement between the carrier frame and the rolling assembly, or inform an operator, if the center of gravity of the carrier frame with its tool(s) and a central point of the rolling assembly do not at least approximately coincide.

8. The agricultural machine according to claim 1, further comprising an evaluation and control means which is configured and programmed to: i) analyze the data supplied by measuring means for the ballast weight of the tool or tools mounted at the front or at the rear, and by relative position detection means for the tool or tools mounted at the front or at the rear and movable with respect to the carrier frame, for example by raising/lowering, and/or, lastly, by a database, ii) determine an optimal relative positioning between the carrier frame and the rolling assembly, and iii) if necessary, either perform an adjustment by controlling a relative displacement between the carrier frame and the rolling assembly, or inform an operator, if the center of gravity of the carrier frame with its tool(s) and a central point of the rolling assembly do not at least approximately coincide.

9. The agricultural machine according to claim 1, further comprising a database providing predefined states of optimal relative positioning between the carrier frame and the rolling assembly, based on the type of tool(s) or ballast weight(s) mounted at the front and/or at the rear, and means for detecting the type of tool(s) or ballast weight(s) mounted.

10. The agricultural machine (1) according to claim 8, further comprising a database providing predefined states of optimal relative positioning between the carrier frame and the rolling assembly, based on the type of tool(s) or ballast weight(s) mounted at the front and/or at the rear, and means for detecting the type of tool(s) or ballast weight(s) mounted, wherein the evaluation and control means are programmed to analyze the data supplied by the means for detecting the type of tool(s) or ballast weight(s) mounted and to consult the database, at least at the beginning of a working or moving phase of the agricultural machine, and to possibly adjust the relative positioning between the carrier frame and the rolling assembly and/or inform an operator.

11. The agricultural machine according to claim 7, wherein the evaluation and control means (8) are programmed to analyze repeatedly, if necessary almost continuously, the data provided by a measuring means for the balance of the machine, or by a measuring means for the ballast weight and relative position detection means for the tool or tools mounted at the front or at the rear, and to automatically determine and repeatedly adjust, if necessary in real time and continuously, the relative positioning between the carrier frame and the rolling assembly, throughout a working phase of the agricultural machine.

12. The agricultural machine according to claim 1, wherein the evaluation and control means are programmed to also take into account the filling level of the fuel tank of the agricultural machine, and its evolution during the working phase, in order to determine and, if necessary, adjust an optimal relative positioning between the carrier frame and the rolling assembly.

13. A method for managing the configuration of an agricultural machine according to claim 1, the method comprising:
providing a connecting link between the carrier frame and the rolling assembly, which is configured to allow displacement between this frame and this assembly along the longitudinal axis, and
determining and possibly adjusting, if necessary, automatically by an evaluation and control means or upon a command from an operator informed by this means, the relative positioning between the carrier frame and the rolling assembly, in such a way that the center of gravity of the carrier frame with its tool(s) and a central point of the rolling assembly are close to each other, advantageously located in a same plane perpendicular to the longitudinal axis, and preferably coincident.
